(19) United States
(12) Patent Application Publication
(10) Pub. No.: US 2006/0271994 A1
(43) Pub. Date: Nov. 30, 2006

(54) Information output device and information output method, information recording device and information recording method, information output program and information recording program, and information recording medium

(76) Inventor: Kenichiro Tada, Saitama (JP)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/555,692

(22) PCT Filed: May 14, 2004
(86) PCT No.: PCT/JP04/06554

§ 371 Date: Nov. 4, 2005

(30) Foreign Application Priority Data
May 14, 2003 (JP) 2003-136631

(51) Int. Cl. H04N 7/173; H04N 7/16

(52) U.S. Cl. 725/134; 725/142; 725/90

(57) ABSTRACT

[Problem]To provide a broadcast receiver and the like that allow a user to correctly keep track of a change in a program when a digital broadcast is received and recorded. [Means For Solving Problems]A set top box ST that converts a transport stream to be recorded on a hard disk to a recording stream for recording on the hard disk and outputs the converted stream on an information recording/reproduction device SR, wherein an event information table, which is included in a transport stream at input time and which directly indicates a point of a change in the contents of an event constituting the transport stream, is detected from the received transport stream, a DIT corresponding to the detected event information table is generated, the generated DIT is inserted into a recording stream to form the recording stream, and the recording stream is output to the information recording/reproduction device SR.

### TECHNICAL FIELD

The present invention relates to an information output apparatus, an information output method, an information recording apparatus, an information recording method, an information output program, an information recording program, and an information recording medium. More concretely, the invention relates to the information output device, the information output method, the information output program therefore , the recording medium in which the information output program is recorded, the information recording device in which the outputted recording information is recorded, the information recording method, the information recording program therefore, and the information recording medium in which the information recording program is recorded.

### BACKGROUND ART

In recent years, digital broadcasting such as so-called digital high vision broadcasting is starting. As recording density of recording media tends to be heightened recently, recorders and the like, which can receive digital broadcasting originally having high image quality and can record the contents included in the received digital information into optical discs or hard discs while maintaining the image qualities, are being marketed.

Generally in view of convenience, when a program which is sent as the digital broadcasting is received and recorded, it is necessary to detect caesuras (changing points) of the programs and insert, for example, an index or a title when a program which is broadcasted as the digital broadcasting is received.

In the conventional technique, as a conventional mathod of detecting a changed point of the program as described, there is a technique described in Patent Document 1: Japanese Unexamined Patent Publication No. JP-A-11-239185 to treat a so-called partial transport stream in an MPEG 2 method. In the Patent Document 1: Japanese Unexamined Patent Publication No. JP-A-11-239185, according to the methods described in Patent Document 1(FIGS. 1 and 5), by inserting a Discontinuity Information Table(DIT) Program Clock Reference (PCR) at the changed points of so-called Program Specific Information(PSI) or Section Information(SI), the changed points of the program are detected at a time of reproducing.

### DISCLOSURE OF THE INVENTION

Problems to be Solved by the Invention

However, according to the method disclosed in the above described Patent Document 1, there is a problem that the inserted DIT does not show the changed point of the all programs.

In other words, since the PSI is originally generated based on various table information pieces (table information pieces having no relation with changed points of the program) on a transport stream, although contents of a program have a changed point, there is a case where the changed point is not clearly shown.

On the other hand, it is not normalized to necessarily transmit the SI as a partial transport stream. In a device in which the SI is not transmitted, it is impossible to detect the changed point at the time of reproducing.

Further, the DTI is inserted into discontinuous points of Program Clock Reference (PCR) . However, since there is a case where the PCR is necessarily discontinuous, the DIT related thereto cannot be comprehended to show changed points of all programs.

Therefore, the present invention is provided to solve the above problems and to provide an information recording apparatus and method which can record various information pieces into a recording medium under a state where a content of a representative image is prevented from being improperly recognized by a user whom the representative image is improperly presented, an information reproducing device and method which can reproduce the information pieces while restricting reproduction of the recorded information pieces, and a recording medium which records an information recording program for recording the information pieces, an information reproducing program for reproducing the information pieces, and information pieces for the information recording program, the information reproducing program and the control of the reproduction.

Means of Solving the Problem

In order to solve the above problem, according to an invention described in claim 1, an information outputting apparatus for converting recording information which is inputted from an outside as recording information, e.g. a transport stream, to be recorded into a recording medium, e.g. a hard disc, into a recording stream which is recorded into a recording medium and outputting the converted recording stream into an information recording apparatus, comprising:

a detecting device which detects control information respectively for partial recording information pieces including at least time information for showing a change point where the content of the partial recording information pieces which form the recording information out of the inputted recording information; and

an output device which generates instructing information which shows a boarder of the recording stream on the basis of the control information thus detected, inserts the instructing information thus generated to form the recording stream, and outputs it to the information recording apparatus.

Accordingly, the control information is detected from the inputted recording information, the instructing information is generated on the basis of the control information thus detected and outputted into the information recording apparatus. Therefore, the instructing information is generated from the control information which directly shows a change of the partial recording information. Accordingly, it is possible to recognize the instructing information which certainly shows an event that the partial recording information piece is changed.

Accordingly, it is possible to certainly grasp the change of the partial recording information piece at the time of recording or reproducing in the information recording apparatus.

In order to solve the problem, according to the invention described in claim 2, in the information outputting apparatus according to claim 1, the output device is characterized in that the instructing information is inserted at a position of the recording stream which corresponds to a timing being a predetermined time prior to a timing when the content of the partial recording information piece is changed.

Accordingly, the instructing information is inserted at a position of the recording stream which position corresponds to the timing being a predetermined time prior to the timing when the content of the partial recording information piece is changed. Therefore, it is possible to prevent a drop of information just after changing the partial recording information piece, i.e. at the beginning of reproduction of the partial recording information just after the change.

In order to solve the above problem, according to the invention described in claim 3, in the information outputting apparatus according to claim 2, the recording information is inputted from an outside after being compressed by an MPEG method, and the time is a reproducing time of the recording information piece corresponding to one group of picture (GOP) in the MPEG method.

Accordingly, the recording information is inputted from the outside after being compressed by an MPEG method, and the preset time is a reproduction time of the recording information piece corresponding to one group of picture in a MPEG method. Therefore, it is possible to certainly prevent a drop of information just after changing the partial recording information.

In order to solve the above problem, according to the invention described in claim 4, in the information outputting apparatus according to any one of claims 1 to 3, the recording information is inputted through broadcasting, and the control information designates the broadcasting start time of the partial recording information and the broadcasting time of the partial recording information with respect to each of the partial recording information pieces.

Accordingly, because the control information is information designating the broadcasting start time of the partial recording information and the broadcasting time of the partial recording information, it is possible to certainly grasp the change point of the partial recording information which is changed by each recording information pieces.

In order to solve the above problem, according to the invention described in claim 5, in an information recording apparatus which records the recording stream which is outputted from the information outputting apparatus according to any one of claims 1 to 4, it characterized by comprising:

an extracting device such as a micro computer which extracts the instructing information from the recording stream thus outputted; and

a recording device such as a recording unit which records the instructing information thus extracted into the recording medium along with the partial recording information piece corresponding to the instructing information thus extracted.

Accordingly, the instructing information is extracted out of the outputted recording stream which is outputted from the information output device, and the instructing information is recorded into a recording medium along with the corresponding partial recording information. Since the instructing information is generated out of the control information which directly designates the change of the partial recording information. Therefore, it is possible to recognize the instructing information which certainly designates a change of the partial information in the information recording apparatus.

Accordingly, it is possible to certainly grasp the change of the original partial recording information piece at the time of recording or reproducing.

In order to solve the above problem, according to the invention described in claim 6, in an information outputting method of converting recording information such as a transport stream which is inputted from an outside as recording information to be recorded into a recording medium such as a hard disc into a recording stream for recording into the recording medium and outputting the converted recording stream to an information recording apparatus comprising steps of:

a detecting step which detects control information respectively of partial recording information pieces which includes at least time information for designating a change point where a content of the partial recording information such as an event which forms the recording information out of the recording information thus inputted; and

an outputting step which generates instructing information such as an event change information table which designates a boarder of the recording stream on the basis of the control information thus detected, forms the recording stream by inserting the instructing information thus generated into the recording stream, and outputs the recording stream into the information recording apparatus.

Accordingly, it is possible to detect the control information respectively of the partial recording information pieces out of the recording information to be inputted, generate instructing information on the basis of the control information thus detected, form the recording stream by inserting the instructing information thus generated into the recording stream, and output to the information recording apparatus. Therefore, it is possible to recognize the instructing information which certainly designates that the partial recording information is changed by the information recording apparatus since the instructing information is generated from the control information which directly designates the change of the partial recording information.

Accordingly, it is possible to certainly grasp the change of the original partial recording information at the time of recording and reproducing in the information recording apparatus.

In order to solve the above problem, according to the invention described in claim 7, in an information outputting method which is conducted by the information recording apparatus which makes the recording medium record the recording stream outputted from the information output method according to claim 6, comprising:

an extracting step which extracts instructing information out of the recording stream; and

a recording step which records the instructing information thus extracted along with a partial recording information piece corresponding to the instructing information.

Accordingly, since the instructing information is extracted out of the recording stream which is outputted by the information output method, and the instructing information thus extracted is recorded into the recording medium along with the partial recording information piece corresponding to the instructing information, the instructing information is generated from the control information which directly designates the change of the partial recording information. Therefore, it is possible to recognize the instructing information which certainly designates that the partial recording information is changed in the information recording apparatus.

Accordingly, it is possible to certainly grasp the change of the partial recording information at the time of recording or reproducing in the information recording apparatus.

In order to solve the above problem, the invention described in claim 8 causes an output computer, which is included in an information recording apparatus which converts recording information such as a transport stream inputted from an outside as recording information to be recorded into a recording medium such as a hard disc, to perform as:

a detecting device which detects control information respectively for partial recording information pieces which includes at least time information designating a change point where a content of the partial recording information piece forming the recording information is changed out of the recording information to be inputted; and

an output device which generates instructing information such as an event information change table which designates a border of the recording stream on the basis of the detected control information, inserts the instructing information thus generated into the recording stream to form the recording stream and outputting it to the information recording apparatus.

Accordingly, since the control information respectively of the partial recording information pieces is detected out of the inputted recording information, the instructing information is generated on the basis of control information thus detected, the recording stream is formed by inserting the generated instructing information into the recording stream, and the output computer functions so as to output to the information recording apparatus, it is possible to recognize the instructing information which certainly designates that the partial recording information is changed by the information recording apparatus.

Accordingly, it is possible to certainly grasp the change of the original partial recording information at the time of recording and reproducing in the information recording apparatus.

In order to solve the above problem, the invention described in claim 9 causes a recording computer, which is included in the information recording apparatus for recording the recording stream which is outputted from the information outputting apparatus according to claim 8 into the recording medium, to perform as:

an extracting device which extracts the instructing information out of the recording stream thus outputted; and

a recording device which records the instructing information thus extracted along with the partial recording information piece corresponding to the instructing information thus extracted.

Accordingly, the recording computer performs to extract the instructing information out of the recording stream which is outputted from the information output device and record the instructing information thus extracted so as to record into the recording medium along with the partial recording information piece corresponding to the instructing information, the instructing information is generated from the control information which directly designates the change of the partial recording information. Therefore, it is possible to recognize the instructing information which certainly designates that the partial recording information is changed in the information recording apparatus.

Accordingly, it is possible to certainly grasp the change of the original partial recording information at the time of recording and reproducing in the information recording apparatus.

In order to solve the above problem, the invention described in claim 10 is characterized by that the information output program according to claim 8 is recorded so as to be readable by the output computer.

Accordingly, by reading out and executes the information output program by the output computer, the control information respectively for the partial recording information pieces is detected from the recording information to be inputted, the instructing information is generated on the basis of the control information, the instructing information thus generated is inserted into the recording stream to form the recording stream, and the output computer performs so as to output to the information recording apparatus. Since the instructing information is generated from the control information which directly designates the change of the partial recording information piece, it is possible to recognize the instructing information which designates that the partial recording information is certainly changed in the information recording apparatus.

Accordingly, it is possible to certainly grasp the change of the original partial recording information at the time of recording and reproducing in the information recording apparatus.

In order to solve the above problem, the invention described in claim 11 is characterized by that the information recording program according to claim 9 is recorded so as to be readable by the recording computer.

Accordingly, by reading out and executes the information recording program by the recording computer, the instructing information is extracted out of the recording stream which is outputted from the information output apparatus including the output computer according to the seventh present invention, and the recording computer works so as to record the instructing information thus extracted into the recording medium along with the partial recording information piece corresponding to the instructing information. Since the instructing information is generated from the control information which directly designates the change of the partial recording information piece, it is possible to recognize the instructing information which designates that the partial recording information is certainly changed in the information recording apparatus.

Accordingly, it is possible to certainly grasp the change of the original partial recording information at the time of recording and reproducing in the information recording apparatus.

### BEST MODES FOR CARRYING OUT THE INVENTION

Next, a preferred embodiment of the invention will be described in reference of the figures.

The embodiment is about a case where the present invention is applied to a broadcast receiving and recording system which is made up of an information output device (so-called set top box) which receives a broadcasting program which is sent via broadcasting radio waves of a so-called digital television broadcast using an MPEG method as a compression method (hereinafter referred to as a digital broadcasting) and outputs a received information piece corresponding to the received broadcast program and an information recording device which acquires the received information from the receiving device and recording the obtained information piece into the recording medium.

(I) Entire Structure of broadcast receipt recording system

First, the entire structure of the broadcast receipt recording system according to the embodiment will be described in reference of FIGS. 1 to 4. FIGS. 1 to 3 are block charts showing a schematic structure of the broadcast receipt recording system, and FIG. 4 shows a recording format used for recording a broadcast program included in received airwaves.

As shown in FIG. 1, the broadcast receiving system S according to the embodiment records in use of a set top box ST for providing a necessary signal decoding to the airwaves which are received via an antenna ANT and the above information recording and reproducing apparatus SR which receives the above recording stream through a network B formed by a serial bus, an internet protocol(IP) and the like, and records this into a recording medium such as a hard disc and reproduces this.

Next, a detailed structure of the set top box ST and the information recording and reproducing apparatus SR will be described.

First, as shown in FIG. 2, the set top box ST according to the embodiment is formed by a digital broadcast receiving section 1, a demultiplexer 2, a micro computer (hereinafter referred to as micon) 3, a graphics section 5, an image decoding section 6, an on screen display (OSD) section 9, a high speed interface (HSI) section 10, a remote controller 12 which can be carried, and a remote controller light receiving section 11 which receives an information piece which is sent in use of an infrared light.

Next, an entire operation is described.

First, the total operation in a case where the set top box ST receives a digital information piece which is broadcasted by the above airwaves and on air and outputs the information to the information recording and reproducing apparatus SR through a network B, and simultaneously the contents and the like of the received digital broadcast is displayed if necessary will be described.

When an output process and the like are of the digital information are done, the antenna ANT is first receives airwaves, generates a receiving signal Srv corresponding to the received airwaves, and outputs it to the digital broadcast receiving section 1.

Next, when an operation of starting the output process in the remote controller 12, an infrared ray IR which is emitted from the remote controller 12 is received by the remote controller light receiving section 11 in correspondence with the starting operation, and thereby the micro computer section 3 generates control information Scn so as to output it to the network B in receipt of the digital information which is designated in the starting operation and outputs the control information Scn into the digital broadcast receiving section 1.

Accordingly, the digital broadcast receiving section 1 selects the digital information piece corresponding to a channel which is desired in the received digital information under a control by the microcomputer section 3 in receipt of the control information Scn and outputs it to the demultiplexer 2 as digital information Srn. Simultaneously, the digital broadcast receiving section 1 detects PID (Packet ID) respectively of packets which form the digital information in the selected channel and outputs it to the microcomputer section 3 as the control information Scn.

Next, the demultiplexer 2 extracts digital information which should be outputted into the information recording and reproducing apparatus SR out of the digital information Srn and outputs it to the image decoding section 6, the HSI section 10 and the microcomputer 3 as the recording information Spd at a recording rate which is previously set.

Therefore, the image decoding section 6 decodes the digital information which is contained in the recording information Spd and outputs it into the graphics section 5 as the decoding information Sdc.

The graphics section 5 processes the image information which is contained in the decoding information Sdc, makes an image corresponding to the image information thus processed display on a display which is not shown and provided outside as the display information Sv as an analogue signal.

Meanwhile, the voice information included in the record information Spd is decoded by the voice decoding section and thereafter outputted into and propagated from an outside speaker (not shown) along with the process of images in the image decoding section 6 and the graphics section 5.

Further, sub images such as a closed caption or specifications of display which correspond to the images included in the decoding information Sdc are separately generated in the OSD section 9 and outputted into the graphics section 5 as OSD information Sosd into the graphics section 5.

The graphics section 5 superposes the sub images included in the OSD information Sosd on the above-mentioned decoding information Sdc when necessary and generates image information included in the display information Sv by combining the OSD information Sosd and the decoding information Sdc.

At the same time, the HSI section 10 to which the recording information Spd is inputted provides an interface treatment in a digital like manner to the recording information Spd under a control by the micro computer section 3 by sending and receiving the control information Scc and outputs the recording information thus processed to the information recording and reproducing apparatus SR through the network B. Both of an image information piece and a voice information piece as digital information are contained in the output information Sdp.

According to the above-described sequential operations, the image information included in the digital information thus received is outputted to the information recording and reproducing apparatus SR while checking and conducting by an outside display (not shown) and the like.

The microcomputer 3 receives an infrared ray IR which is emitted from the remote control section 12 by the remote controller light receiving section 11 in correspondence with a content of operation for controlling recording process conducted by the remote control section 12, and thereby generates the control information pieces Scn and Sco and the like ,outputs these to the corresponding constitutional components corresponding thereto, and totally control the above-described recording process.

On the other hand, as shown in FIG. 3, the information recording and reproducing apparatus SR is made up of the HSI section 20 which is directly connected to the network B, the reproduction control section 21, the microcomputer 23, the hard disc section HD in which a hard disc HD for recording the digital information is recorded in a recording format shown in FIG. 4, a portable remote controller 26, and a remote controller receiving section 25 which receives an information piece sent from the remote controller 26 as an infrared ray and the like.

Next, the entire operations will be described.

First, in use of the information recording and reproducing apparatus SR, the recording information Spd being the digital information which is sent from the set top box ST through the network B is received and recorded into the hard disc HD.

At the time of recording, when an operation of starting the recording process is first conducted by the remote control section 26, the microcomputer 23 generates the control information Scc on the basis of the operation information Sop outputted from the remote controller light receiving section 25 by receiving the infrared ray that is emitted from the remote controller 26 in correspondence with the starting operation so as to obtain the digital information which is designated in the starting operation and record it into the hard disc HD, and outputs the control information Scc into the HSI section 20.

Accordingly, the HSI section 20 provides an interface process in a manner of digital to the recording information Spd which is sent under control of the microcomputer 3 upon receipt of the control information Scc and outputs it to the recording section 22.

Accordingly, the recording section 22 extracts a digital information piece which should be recorded into the hard disc HD which is previously selected out of the recording information Spd and outputs it to the hard disc section 24 including the hard disc as the recording information Sr.

Accordingly, theharddiscsection24 records the recording information Sr including necessary digital information above described into the integrated hard disc HD under a control by the microcomputer 3 which is driven by sending and receiving the control information Ssh.

Next, an operation of reproducing the digital information which is recorded into the hard disc HD as described above will be described.

At the time of reproducing, when an operation of starting the reproducing process is instructed through the remote control section 26, an infrared ray IR which is emitted from the remote control section 26 in correspondence with the starting operation is received by the remote controller light receiving section 25, the microcomputer 23 generates the control information Ssh so as to detect the digital information designated by the starting operation and outputs it to the hard disc section 24.

Accordingly, the hard disc section 24 detects the digital information which is designated by the control information out of the hard disc section HD and outputs it to the reproduction control section 21.

Further, the reproduction control section 21 provides a reproduction process which is previously set up to the digital information which is contained in the detecting information Sp generates the reproduction process information Spp and outputs it to the HSI section 20.

The HSI section 20 provides an digital interface process to the reproduction information Spd under a control of the microcomputer 23 by sending and receiving the control information Scc and outputs this to a digital television set and the like which is not shown and provided outside as output information Sdp as the digital information. In the output information Sdp, both the image information and the voice information are included as the digital information.

Next, the recording format which is used at the time of recording the digital information to the hard disc HD in the information recording and reproducing apparatus SR having the above structure is concretely described in reference of FIG. 4. The recording format shown in FIG. 4 is a logic recording format which is used at the time of recording the digital information to the hard disc HD. Further, FIG. 4 is to schematically and hierarchically show a recording format after recording the digital information into the hard disc on the basis of the recording format.

Meanwhile, as for the physical format used at the time of recording into the hard disc HD of the digital information, a well-known physical format used for the hard disc HD is used as is.

In the beginning, summary of various concepts which are adopted in the recording format in order to efficiently manage the content of the recorded digital information, which contains both of voice information and an image including a static image and a dynamic image, and a recording mode will be described as a premise for understanding the recording format.

First, in the following recording format, a concept of “unit” is used as a measure for handling the recorded digital information. Namely, “unit” is a piece of digital information which is to be recorded into the hard disc HD in a time continuous manner. More concretely, for example, when a piece of the digital information is broadcasted by digital broadcasting such as a Broadcast Satellite (BS) digital broadcasting, an event in the digital broadcasting is defined as one unit.

Second, in the following recording format, during for example the digital broadcasting, a concept of directory is used at a portion of PID which stores an image information and the like of the transport stream of the broadcasting airwaves to be described below, which portion is made up of the same packets in accordance with an intention on the sender side. In other words, the term “directory” represents a zone which is specified by one unit in its entirety or a part of the unit, which unit is occupied by the same PIDs.

Third, in the following recording format, a concept of application GOP is used for showing a zone of transferring G.OP which is mentioned in the MPEG standard within the directory.

Next, on the basis of various concepts described above, a logical recording format related to the embodiment will bee described.

As shown in FIG. 4, on the hard disc HD with the necessary digital information recorded thereon, unit information INF being a control information in correspondence with each of the above described units, and a single or a plurality of stream information pieces SOB, which are actually digital information pieces themselves, are recorded.

Next, as shown in FIG. 4, the above unit information INF is an information piece related to the above unit. The unit information is made up of a preliminary information RSV (4 bytes) that relates to recording of the unit and is unnecessary for the control, a program starting time information EST (5 bytes) that shows a broadcast starting time on airwaves of the recorded event, a program broadcasting time information EDUR (3 bytes) for showing a broadcasting time on airwaves of the recorded event, a directory number information DN(2 bytes) that shows the number of the directories which are allocated for each identification number PID of the packets which transport image information of a transport stream (hereinafter appropriately referred to as TS) with respect to the unit at the time of broadcasting the digital information, directory reference position information DS1 to DSn (respectively 4 bytes) for showing a position of the directory information (to be described below), being attribute information and the like with respect to each of the directories, from the top, and the directory information DIF1 to DIFn. At this time, the information related to the present invention is the above described program starting time information piece EST and the program broadcasting time information piece EDUR.

Next, a detailed structure of each of the directory information pieces will be described.

As shown in FIG. 4, the directory information DIF is made up of a directory size information DS (4 bytes) showing the number of the TS packets included in the corresponding directory, a directory display time information DPTM(4 bytes) that shows the total display time of an image identified by a video PID, the image is image information included in each directory, a video packet identifying information VID(2 bytes that shows the number PID for identifying a packet which transports a unique image information among the directories, a frame code information FC (1 byte) that shows a basic display frequency of basic information, a preliminary information RSV(1 byte) , a packet pointer PPT(4 bytes) that shows a position where an existence of a TS packet is first recognized in use of the byte number from the tops of directories when each directory is recorded, a GOP packet pointer GPP (4 bytes) that shows a position where an existence of an application GOP is first recognized in use of the packet number from the tops of directories when each directory is recorded, a pointer table number information PTN that shows the number of applications GOP included in each directory, and pointer tables PT1 to PTm that show attribution information and the like of each application which is included in the directories.

Further, a detailed structure of the pointer table will be described as follows.

AS shown in FIG. 4, the pointer table PT is made up of a GOP size information GPSZ (4 bytes) that shows the packet number included in the application GOP, a display time information PBTM (2 bytes) that shows the total display time of the image information which is identified by the GOP size information GPSZ (4 bytes) and a first reference image size information FESZ (2 bytes) that shows the number of packets counted from the first packet of the application GOP until the last packet including the first reference image in the application GOP.

Further, as for the relationship between the recording format (logical format) and a physical format of the hard disc (HD) shown in FIG. 4, one stream information SOB includes one of a plurality of aligned units ALU sections of information on the hard disc HD as shown in FIG. 5. Further, one aligned unit ALU is made up of one or a plurality of sectors having the information amount of 512 bytes in an ordinary hard disc HD. One sector SR does not belong to adjacent two aligned units, and one aligned unit ALU does not belong to adjacent two pieces of stream information.

Further, the one stream information is ordinarily recorded so as to correspond to the above event.

(II) Embodiment of the Present Invention

Next, the receiving process and the recording process of the digital broadcasting according to the present invention which is executed in the broadcasting receiving and recording system S of the above structure will be specifically described in reference of FIGS. 6 to 13.

As described below, in the broadcast receiving and recording system S, when digital information included in airwaves of received digital broadcasting is converted to a recording stream for sending to the information recording and reproducing apparatus SR, a change point (more specifically a change time) of an event in a transport stream of the received airwaves is detected and reflected into the recording stream to be generated mainly in the process of generating the recording stream in the set top box ST so as to assuredly reflect the information showing a point of change (a change point H) of the events onto the recording stream for the information recording and reproducing apparatus SR.

(A) Embodiment of Set Top Box

First, in reference of FIG. 6, an entire structure of the two processes which are conducted in the set top box ST will be described. FIG. 6 is a flow chart for showing the entire processes.

As shown in FIG. 6, in the set top box according to the embodiment, the received digital broadcasting is confirmed whether or not the operation of outputting into and recording from the information recording and reproducing apparatus SR is conducted by the remote controller 12 in Step S1, and the process remains when it is not conducted along “NO” in Step S1. When it is conducted along “YES” in Step S1, a time normalizing process for normalizing a system clock (not shown) which is included in the micro computer 3 in the set top box 3 in use of the time information included in the received digital broadcasting (more specifically time information which is counted by a standard clock inside a broadcasting station which broadcasts the digital broadcasting ) in Step S10, an event recognizing process in Step S20 for recognizing a start time and the like of each event which is included in the received digital broadcasting, an event change detection process for detecting the recognized change point of the event in Step S40, and a stream sending process for sending the recording process to which the change point is reflected to the information recording and reproducing apparatus SR in Step S60.

Further, it is checked-whether or not an operation of ending an output process is conducted in the remote control section 12 in Step S70, and when if it is not conducted along NO in Step S70, processes of Steps S10, S20, S40 and S60 are continuously conducted independently and mutually in parallel. Meanwhile, when if the ending process is conducted along YES in Step S70, a process in the set top box ST according to the embodiment is completed.

Next, processes of the above described Steps S10, S20, S40 and S60 are respectively described in detail.

First, as for the time normalizing process in the above Step S10 will be described in reference of FIG. 7. FIG. 7 is a flow chart for showing the time normalizing process. As shown in FIG. 7, in the time normalizing process in Step S10 according to the embodiment, it is checked whether or not an operation of stopping the receiving and recording process according to the embodiment is constantly monitored by a remote control section in Step S11. When the operation is conducted along S11 in Step S11, a process transfers to Step S70 shown in FIG. 6. On the contrary, if the operation is not conducted along S11 of Step S11, a packet within the transport stream as the digital broadcasting is received in Step S12. In Step S13, it is checked whether or not the time information which is counted by the standard clock in the broadcasting station which has broadcasted the digital broadcasting is included in this packet for example in a form of a time offset table and the like in Step S13.

Further, when the time information is not included therein along NO in Step S13. The process returns to Step S11 and the following process is repeated. Meanwhile, when the time information is included in the packet which the time information receives in Step S12 along YES in Step S13, the time information is decoded by the microcomputer 3 in Step S14. Thereafter, the system clock which indicates the standard time of the operation of the set top box ST inside the microcomputer 3 is normalized so as to match the time information thus decoded in Step S15. The process returns to the above Step S11, and the previous process is repeated.

Next, the event recognizing process in Step S20 will be described in reference of FIG. 8. FIG. 8 is a flowchart for showing the event recognizing process. As shown in Figure 8, in the event recognizing process according to the embodiment in Step S20 of the present invention, first an event recognition flag which is a parameter for showing whether or not the recognition of the new event is completed in a register (not shown) and the like in the microcomputer 3 as the microcomputer 3 is initialized in Step S21, and the event change notice flag which is a parameter for showing whether or not a preparation of notifying a change point for changing the event to the information recording and reproducing apparatus SR by adding the change point to the recording stream of the information towards the information recording and reproducing apparatus SR is completed is initialized in Step S22.

After the initialization of the flags is completed, it is constantly monitored that an operation of stopping the receiving and recording process is done by the remote control section 12 in Step S23. When the operation is done along YES in Step S23, the process moves to the process of Step S70 shown in FIG. 6. Meanwhile, when the operation is not conducted along NO in Step S23, a packet in the transport stream as a digital broadcasting is received in Step s24. In Step S25, it is checked whether or not an event information table having a predetermined and specific PID is received in the packet in Step S25.

Here, the event information table includes attribute information showing attributes of each of events in on-air digital broadcasting, broadcast start time information representing the broadcast start time of the event, broadcast time information representing a requisite time for broadcasting the event and the like are included along with a specific PID so as to be mutually distinguishable event by event. Therefore, in the present invention, it is judged that the event which is currently received is changed to the other event in use of the broadcast start time information and the broadcast time information.

In other words, in the judgment of Step S25, when the specific event information table is not received along NO in. Step S25, the process returns to the above Step S23 and the process by the time is repeated by returning to the process of the above Step S23. Meanwhile, when it is received along YES in S25, it is checked whether or not the event information section having the predetermined and specific table ID within the received specific event information table is received in Step S26.

Here, the event information section includes the attribute information, the broadcast start time information, and the broadcast time information out of the event information table, along with the specific table IDs so as to be mutually distinguishable event by event, wherein the broadcast start times and the broadcast times of each of the events are obtainable event by event.

When the specific event information section is not received in the judgment along NO in Step S26, the process up to the present is repeated after returning again to the process of the above Step S23. When it is received along YES in Step S26, it is confirmed whether or not the value of the event recognition flag is “O” or not, namely whether or not the event itself of the digital broadcasting is yet recognized, at a time when the event information section is received in Step S27.

In the judgment of Step S27, when the value of the event recognition flag is “0”, namely when the currently broadcasted event is not recognized along YES in Step S27, it is confirmed whether or not the next event indicator showing that the obtained event information is a program which is currently broadcasted is “1” in the transport stream that is received in Step S28.

Then when the next event indicator is not “1”, in other words it is not the currently received information along NO in Step S28, since it is impossible to obtain a change point of the currently received event (information such as an end time) is not obtainable, the process returns to the above Step S23 and the process up to the present is repeated. Meanwhile, when the next event indicator is “1”, namely when it is the currently receiving event information along YES in Step S28, since a change point of the currently receiving event (information such as the program starting time and the ending time) is obtainable, the value of the broadcast starting time information piece corresponding to the currently receiving event is received from the above event information section and described in a unit information temporary file which is formed inside a memory (not shown) in the microcomputer for sending to the information recording and reproducing apparatus SR in Step S29. In a manner similar thereto, the value of the broadcasting time information piece corresponding to the current event is obtained from the above event information section and described in the unit information temporary file in Step S30. According to these processes, the above event flag is changed to “1” in Step S31 to show that the currently receiving event is recognized. Then the process returns to the above StepS23 and the process up to the present is repeated.

On the other hand, in judging Step S27, when the value of the event recognition flag is “1”, namely when one event is currently recognized by the processes of the above Steps S28 to S31 along NO in Step S27, it is confirmed whether or not the next event indicator is “1” inside the received transport stream in Step S32.

Then when the next event indicator is not “0”, namely it is not an information piece which follows the currently received event along NO in Step S32, since it is impossible to obtain the starting point (information such as program starting time) of the event next to the currently receiving event, the process up to the present is repeated after returning to the process of the above Step S233. Meanwhile, when the next event indicator is “0” in a case where the information piece to be treated is the information piece next to the currently received event along YES in Step S32, the starting point of the event next to the currently received event (information such as the program starting time) is obtainable, the value of the broadcast starting time information piece corresponding to the event next to the currently receiving event is obtained from the above event information section and described in a next event disclosure time information file which is formed in a memory area (not shown) in the microcomputer 3 and provided to send to the information recording and reproducing apparatus SR in Step S33. Ina similar manner thereto, the value of the broadcast time information piece corresponding to the next event is obtained from the above event information section and described into the next event time information file which is formed inside the memory region (not shown) of the microcomputer 3 and provided to send to the information recording and reproducing apparatus SR in Step S34. According to these processes, it is established that the information of the event following the currently receiving event is obtained and the information related to the change point of the currently receiving event is ready for notification, the event change notice flag is changed to “1” in Step S35, and the process returns to the above Step S23 and the processes up to the present are repeated.

Next, the event change detection process as Step S40 will be described in reference of FIG. 9. FIG. 9 is a flowchart for showing the event recognition process.

As shown in FIG. 9, in the event change detection process according to the embodiment in Step S40, first a event reference number flag as a parameter for showing the number of events which are sent out of the set top box ST as the record stream is initialized in Step S41.

Then after initializing the event reference flag, it is constantly monitored whether or not an operation of stopping the recording and receiving process is conducted in the remote controller 12 in Step S42. When the operation is conducted along YES in Step S42, the process moves to Step S70 shown in FIG. 6. On the other hand, when the operation is not conducted along NO in Step S42, a packet in the transport stream is received as the digital broadcasting in Step S43. Then it is confirmed whether or not preparation of notifying to the information recording and receiving apparatus. SR is completed while including the change point for changing the event into the recording stream for the information recording and reproducing apparatus SR in Step S44. When the value of the event change notice flag is not “1” along NO in Step S44, since it is not possible to notify the change point, the process returns to the above Step S42. Then the process as before is repeated again. Meanwhile, when the value of the event change notification flag is “1” along YES in Step S44, the time of the system clock which is normalized by the process in Step S10 in Step S45. Further, the obtained time is confirmed whether or not a time of 0.5 seconds earlier than the time described in the next event disclosure information file in Step S46. The time of 0.5 seconds corresponds to a reproduction time of an image and a sound which are included in one GOP in an MPEG method used. in digital broadcasting.

Accordingly, when the obtained time does not show the time of 0.5 seconds earlier than the time described in the next event disclosure time information along NO is Step S46, since the event change point does not reach the event change point (change time) the process returns to the process of Step S23. Meanwhile, when the obtained time shows a time 0.5 seconds earlier than the time described in the next event disclosure time information along YES in Step S46, it is established that a time for inserting the event change information table arrives so as to directly insert the event change information table into the recording stream for sending to the information recording and reproducing table or replace a packet which is to be sent and exists in the recording stream at the present time with the event change information table and insert it in Step S47. Further, the above event change information table is an information table which is described so as to be recognized a change of the event in the information recording and reproducing apparatus SR.

After the insertion and replacement of the event change information table are completed, a packet including the event change information table is sent to the information recording and reproducing apparatus SR as a part of the recording stream in Step S48. A file sending flag which shows that the above unit information INF on which the contents of the change notice flag, the event recognition flag and the event information table are reflected is sent by initializing the file sending flag to be described below in Step S49. Then the event reference number flag is increased by “1” in Step S50. The process up to the present is repeated after returning to the process of Step S42 so as to conduct a process shown in FIG. 9 which has been described as for the next event.

Next, the stream sending process as the above Step S60 will be described in reference of FIG. 10. FIG. 10 is the flow chart for showing the stream sending process.

As shown in FIG. 10, in the stream sending process (Step S60) according to the Embodiment, first the file sending flag is initialized in Step S61, and thereafter it is constantly monitored whether or not the receiving and recording process, described in the Embodiment, is operated to stop by the remote controller 12 in Step S62. When the operation is conducted along YES in Step S62, the process moves to Step S70 shown in FIG. 6. When the operation is conducted along NO in Step S62, the process moves to Step S70 shown in FIG. 6. Next, it is confirmed whether or not the value of the event recognition flag is “1” or not, namely whether the currently receiving event is recognized in Step S63, when it is not recognized yet along NO in Step S63, the process returns to Step S62 and the process up to the present is repeated.

Meanwhile, when the value of the event recognition flag is “1” and the currently receiving event is recognized along YES in the judgment in Step S63, it is confirmed whether or not the event change information table showing the change point of the event is already sent in Step S64. When it is already sent along YES in Step S64, the process returns to the above Step S62 so as to repeat the above described process for the next event. On the other hand, when it is not sent along NO in Step S64, the value of the event reference number flags is described into the unit information temporary file (vide Steps S29 and S30 in FIG. 8) in Step S65, and thereafter the unit information temporary flag is sent as the above unit information INF to the information recording and reproducing apparatus SR in Step S66. Thereafter, the value “1” of the file sending flag is renewed to “1” and the process returns to Step S62. Then the above described process is repeated with respect to the next event.

Finally, modes of the recording stream of the above described Steps S1, S10, S20, S40, S60 and S70 are specifically described in reference of FIG. 11. Meanwhile, FIG. 11 is a schematic view of comparing a packet RT in the transport stream which is broadcasted as digital broadcasting (the upper row of FIG. 11) and a packet PT in the recording stream corresponding to the output information Spd on a time axis.

According to the above described sequential processes, as shown in FIG. 11, at a time position in the recording stream which corresponds to a time 0.5 seconds earlier than the change time of the event in the transport stream as shown in FIG. 11, the event change information table DIT for showing the above mentioned change time of the event is inserted. In order to enhance a detection accuracy of the event change information table DIT in the recording and reproducing apparatus SR, it is preferable to insert two sequential packets corresponding to the event change information table into the recording stream. When the change point of the stream information SOB as the recording stream is in agreement with a time of carrying the packet in which a display image is carried in correspondence with the event change time as shown in FIG. 11.

(B) Embodiment of a Recording Operation in an Information Recording and Reproducing Apparatus

Next, a recording process of the information recording and reproducing apparatus SR at the time of recording the recording stream, which is sent from the above-described set top box ST, into the above-described hard disk in use of the recording format shown in FIG. 4 will be described in reference of FIGS. 12 and 13.

First, the recording process is described in reference of FIG. 12. FIG. 12 is a flow chart for showing the recording process.

As shown in FIG. 12, in the recording and reproducing apparatus SR according to the embodiment, when the recording stream from the set top box ST is recorded into the hard disk HD, first a reference flag showing the number of the packets PT which are recorded into the hard disk HD is initialized in Step S80. Next, the recording start position of the stream information SOB (FIGS. 4 and 5) including an aligned unit ALU (FIG. 5) on the hard disk HD is obtained based on the hard disk HD and temporarily memorized into a memory (not shown) inside the microcomputer 23 on the basis of the hard disk HD in Step S81. Further, it is constantly monitored whether or not an operation of stopping a recording process according to the embodiment is operated to stop the recording process of the embodiment by the remote control section 26 in Step S82. When the operation is conducted along YES in Step S82, the recording process is terminated. On the other hand, when the operation is not conducted along NO in Step S82, a piece of the packet PT which is sent as the recording stream is received in Step S83. Further, the information in the received packet is recorded at a position of record in the hard disk HD in Step S84. Then the above-mentioned reference flag is increased by “1” in Step S85.

Further, in the example shown in FIG. 11, it is confirmed whether or not two consecutive event change tables DIT are detected in a case where the two event change information tables DIT are inserted into the recording stream in Step S86.

In the judgment of Step S86, when the two consecutive event information tables DIT are detected along YES in Step S86, a record end position of the stream information SOB on the hard disk HD is obtained on the basis of the hard disk HD and temporarily memorized on the memory inside the microcomputer 23 in Step S87. Then the process moves to the above-mentioned Step S80 so as to receive next packet from the set top box ST.

Meanwhile, in the judgment of Step S86, when the two consecutive event change tables are not detected along NO in Step S86, it is confirmed whether or not the value of the reference number flag showing the packet number which is received in the one aligned unit at the present time reaches a predetermined set number or not in Step S88. When the value of the reference flag does not reach the packet number along NO in Step S88, the process moves to the above-mentioned Step S82 so as to receive a next packet PT from the set top box ST. On the other hand, when the value reaches the packet number along YES in Step S88, the process moves to Step S80 so as to repeat the above process for the next aligned unit ALU.

Further, although it is not shown in FIG. 11, when the recording of all stream information pieces SOB to the hard disk HD is completed, the unit information INF shown in FIG. 4 is formed in use of the unit information temporary file which is sent in the process shown in Step S60 of FIG. 10, and the information is recorded into the hard disk HD along the recording format shown in FIG. 4.

Next, a mode on the hard disk HD which records the recording stream according to the process shown in FIG. 12 will be specifically described in reference of FIG. 13. FIG. 13 schematically shows a relationship between the aligned unit ALU and the packet PT on the hard disk HD on the time axis after the digital information is recorded.

According to the above-described sequential process, as shown in FIG. 13, a boarder of the one aligned unit ALU is in agreement with the stream information SOB, and each packet PT is recorded.

Namely, according to the recording process shown in FIG. 12, when the event change table is resultantly received in the information recording and reproducing apparatus SR, the recording stream following the next packet PT is recorded from the top of the aligned unit ALU which is unrecorded. At this time, when it is tried to bring the border of the stream information SOB in agreement with the border of the aligned unit ALU, as shown in FIG. 13, the event change information table is inserted after inserting a requisite number of null packets including no information so as to make the border of the packet PT in agreement with the border of the aligned unit ALU.

As described above, according to the operation of set top box ST and the information recording and reproducing apparatus SR, the event information table included in the transport stream of the digital broadcasting is detected, the event change information table DIT which shows the change time of the event is generated, the generated event change information table DIT is inserted into the recording stream and outputted to the information recording and reproducing apparatus SR. Accordingly, the event change information table DIT is generated from the event information table which directly shows a change of the event. Therefore, the event change information table DIT which certainly shows that the event is changed can be recognized by the information recording and reproducing apparatus SR.

Accordingly, the change of the event to be described below is certainly grasped at the time of recording to and reproducing from the information recording and reproducing apparatus SR.

Further, since the event change information table DIT is inserted at a position corresponding to a time of 0.5 seconds earlier than a time when the content of the event is changed, it is possible to prevent a drop of shot just after changing the event (namely at a initial stage of event after the change.

Further, since the event change information table is recorded in correspondence with the event broadcasting starting time and the unit information INF showing the broadcast time, it is possible to certainly grasp the change points of the events which are changed at each broadcasting.

Although a case where the present invention is applied to the information recording and reproducing apparatus SR for recording the recording stream onto the hard disk HD has been described, besides this, it is also possible to apply the present invention to a case where the recording stream is recorded into an optical disk of a large capacity such as a digital versatile disc (DVD) , a tape medium and a semiconductor recording medium.

Further, in the above embodiment, although a case where an event change information table DIT is inserted 0.5 seconds earlier than the event change time has been described, it is also possible to insert the event change information table DIT just before the actual change time (vide FIG. 11) of the event in addition thereto.

Further, the programs corresponding to the flowcharts respectively shown in FIGS. 6 to 10 and FIG. 12 are recorded in the recording medium such as a flexible disk and a hard disk or through a network such as an internet. When the programs are read out of a general-purpose CPU and conducted, the CPU is operated as the microcomputer 3 or 23.

### BRIEF DESCRIPTION OF THE DRAWINGS

FIG. 1 is a block diagram for showing a schematic structure of a broadcast receiving and recording system according to the embodiment;

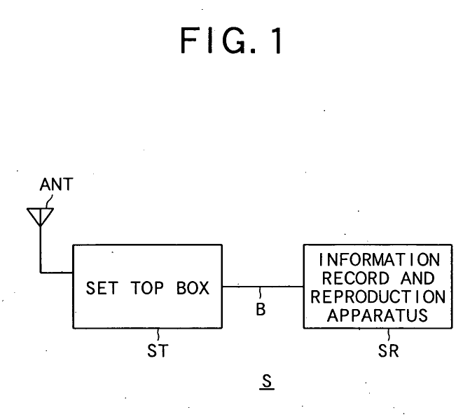

FIG. 2 is a block diagram for showing a detailed structure of the set top box according to the embodiment;

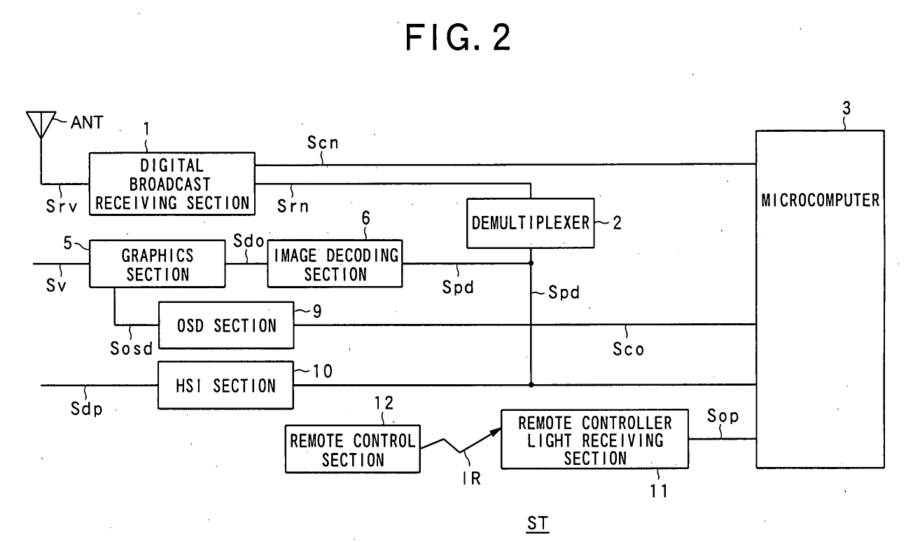

FIG. 3 is a block diagram for showing a detailed structure of an information recording and reproducing apparatus according to the embodiment;

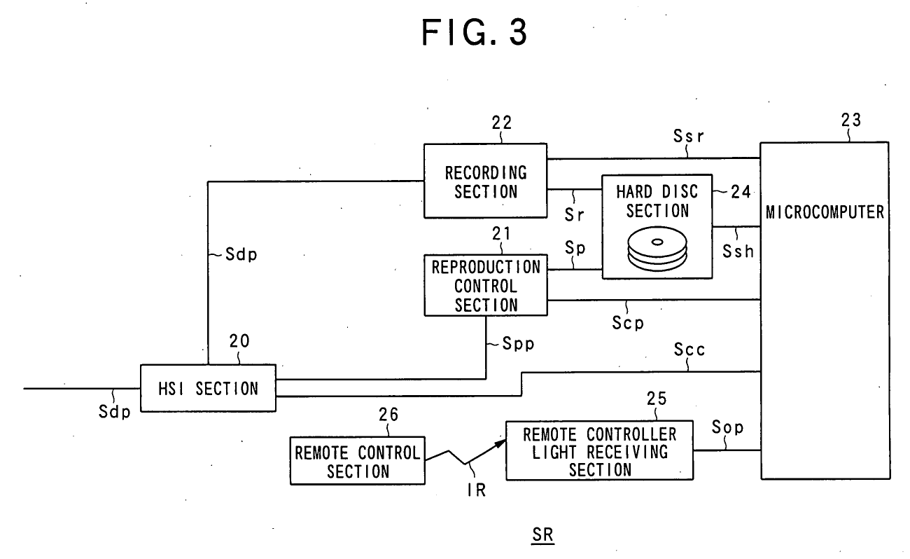

FIG. 4 shows a schematic structure for showing a recording format according to the embodiment;

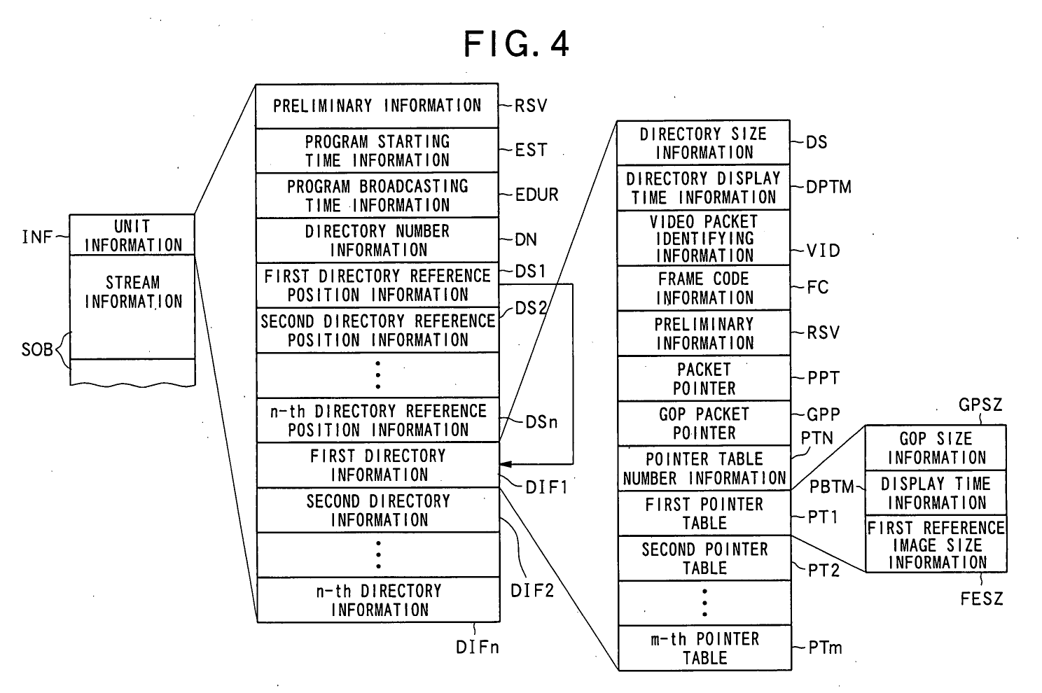

FIG. 5 shows a schematic structure of a relation between a recording format and a physical format according to the embodiment;

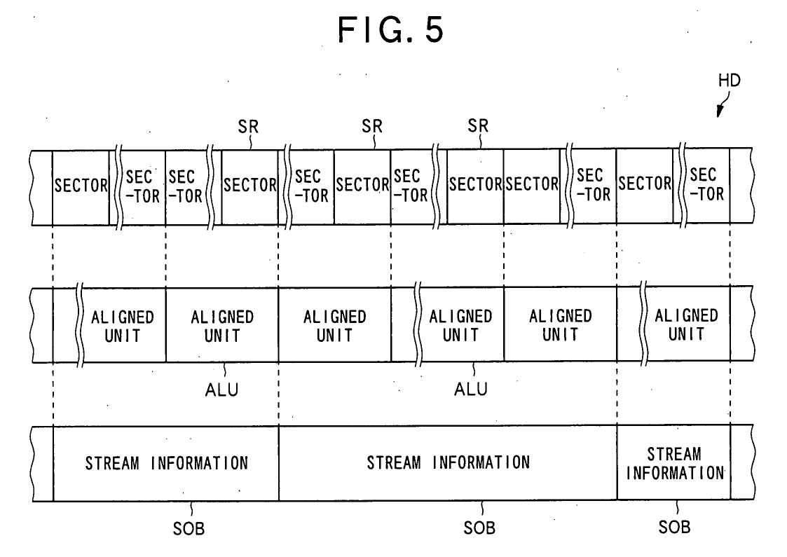

FIG. 6 is a flowchart showing an entire recording stream generation process according to the embodiment;

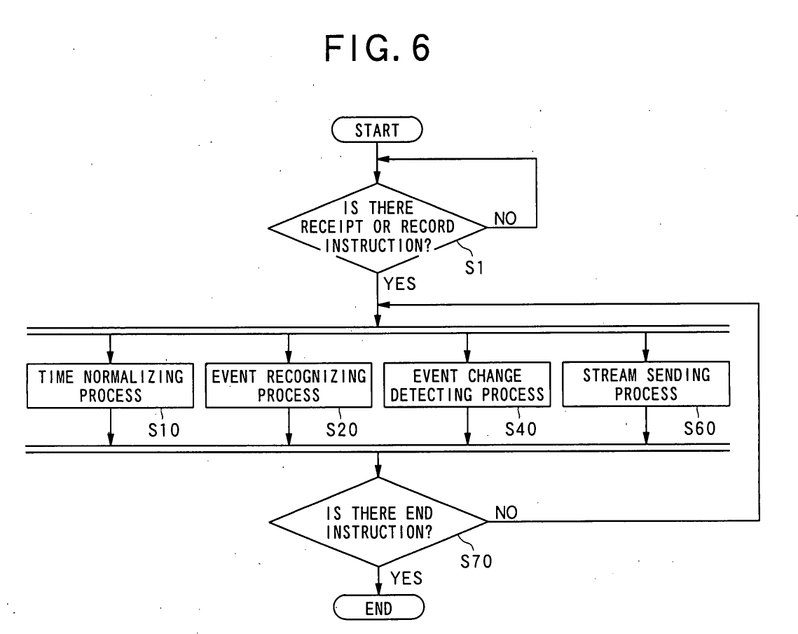

FIG. 7 is a flowchart for showing a time normalizing process according to the embodiment;

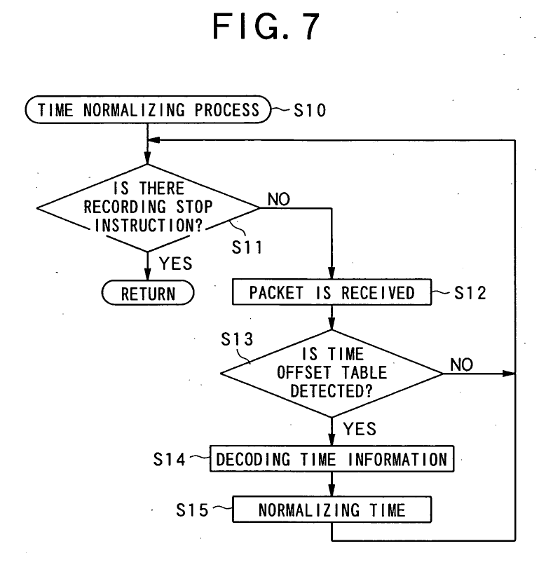

FIG. 8 is a flowchart for showing an event recognition process according to the embodiment;

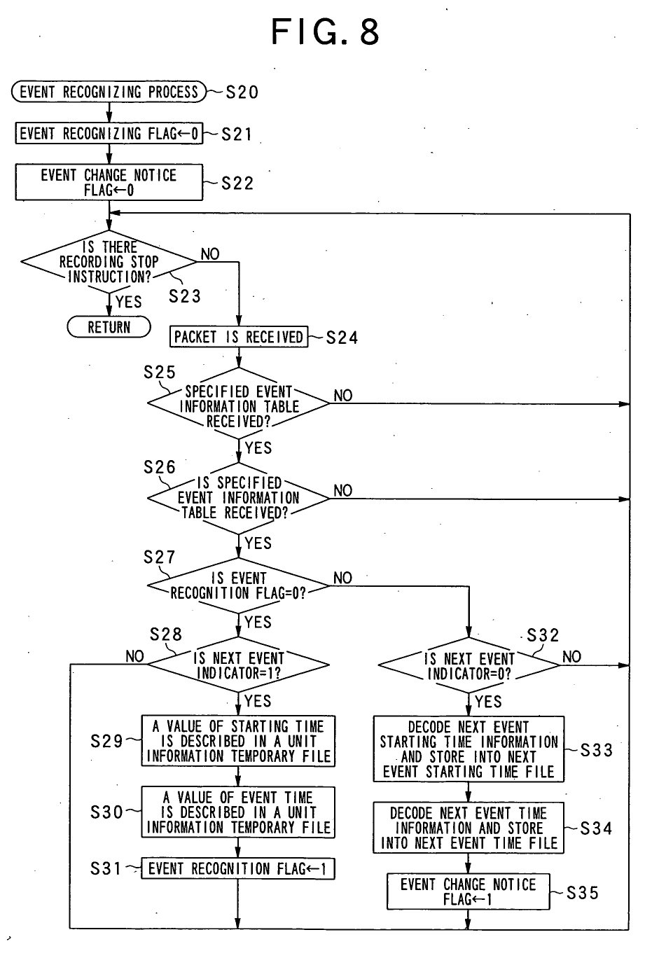

FIG. 9 is a flowchart for showing an event change detection process according to the embodiment;

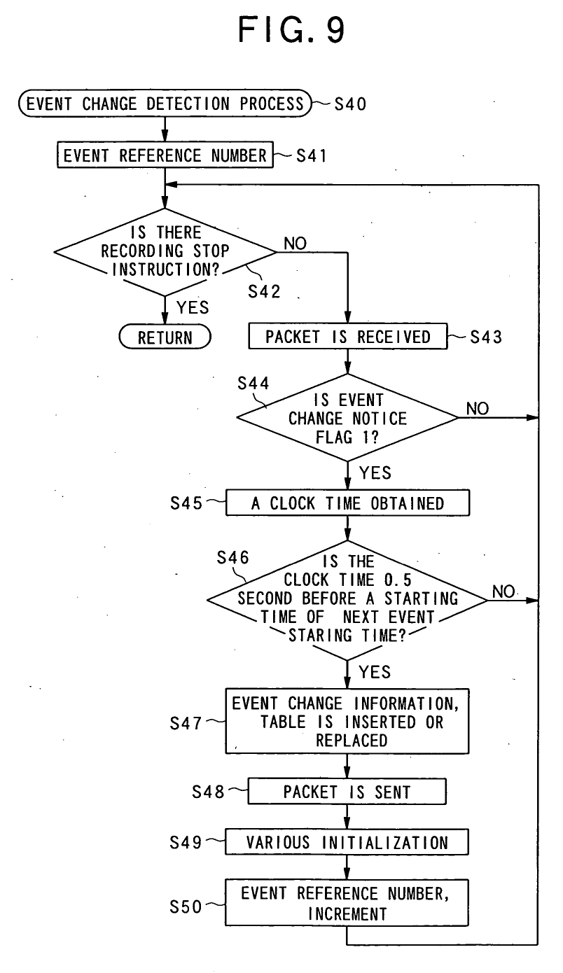

FIG. 10 is a flowchart for showing an stream sending process according to the embodiment;

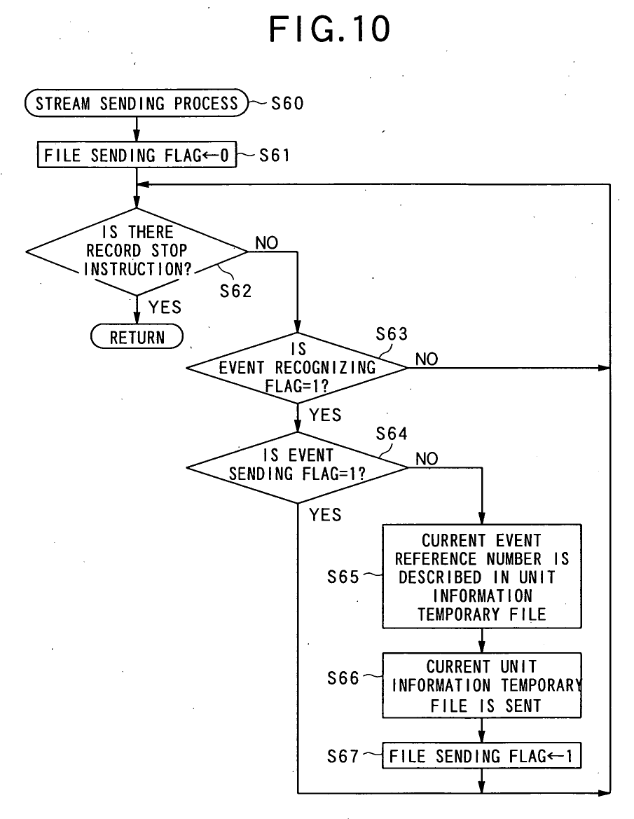

FIG. 11 shows a schematic structure of a mode of a recording stream according to the embodiment;

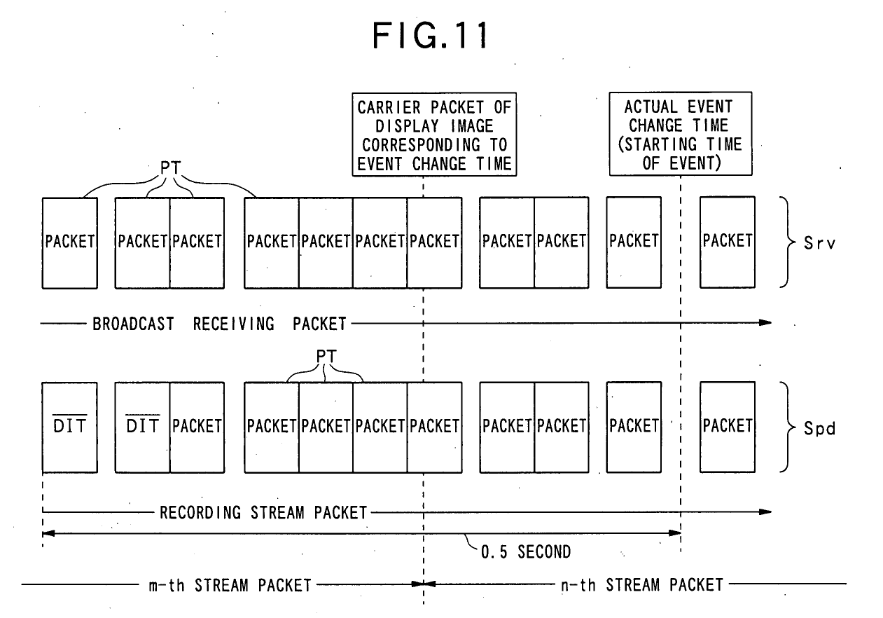

FIG. 12 is a flowchart for showing a recording process according to the embodiment; and

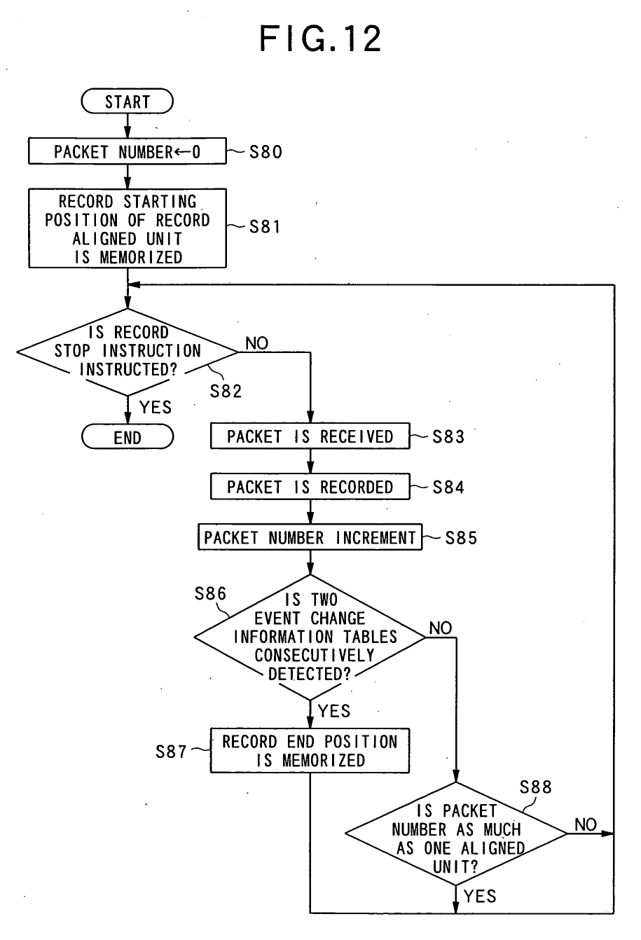

FIG. 13 shows a schematic structure of a mode of a recorded hard disc according to the embodiment.

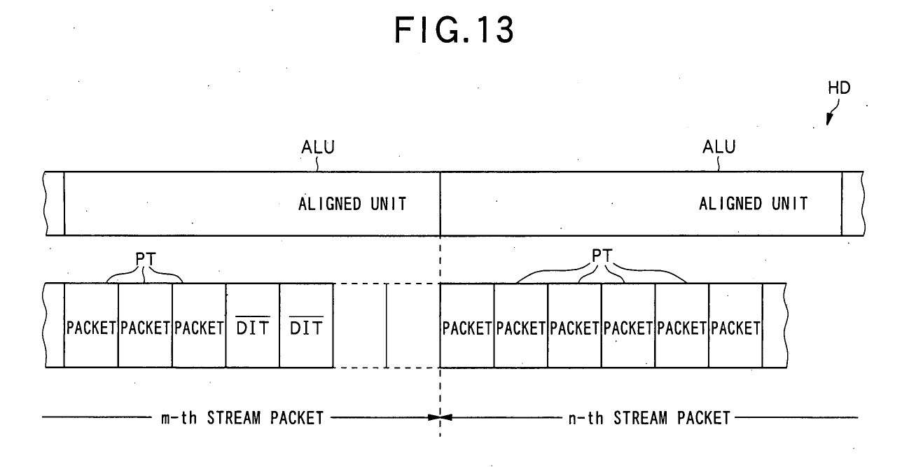

### DESCRIPTION OF REFERENCE NUMERALS

1 DIGITAL BROADCAST RECEIVING SECTION
2 DEMULTIPLEXER
3, 23 MICROCOMPUTER
5 GRAPHICS SECTION
6 IMAGE DECODING SECTION
9 OSD SECTION
10,20 HSI SECTION
11,25 REMOTE CONTROLLER LIGHT RECEIVING SECTION
12,26 REMOTE CONTROL SECTION
21 REPRODUCTION CONTROL SECTION
22 RECORDING SECTION
23 MICROCOMPUTER
24 HARD DISC SECTION
S BROADCAST RECEIVING AND RECORDING APPARATUS
ST SET TOP BOX
SR INFORMATION RECORDING AND REPRODUCING APPARATUS
B NETWORK
HD HARD DISC

1. An information outputting apparatus for converting recording information, which is inputted from an outside as recording information to be recorded into a recording medium, into a recording stream for record, and outputting the converted recording stream into an information recording apparatus, comprising:
a detecting device which detects control information respectively for partial recording information pieces including time information for designating a change point where a content of the partial recording information piece which forms the recording information are detected from the inputted recording information; and
an output device which generates instructing information designating a boarder of the recording stream on the basis of the control information thus detected, inserts the instructing information thus generated to form the recording stream, and outputs it into the information recording apparatus.

2. The information outputting apparatus according to claim 1, wherein
the instructing information is inserted at a position of the recording stream which corresponds to a timing being a predetermined time prior to a timing when the content of the partial recording information portion is changed.

3. The information outputting apparatus according to claim 2, wherein
the recording information is inputted from an outside after being compressed by a moving picture express group (MPEG) method, and
the predetermined time is a reproducing time of the recording information which corresponds to one group of picture (GOP) in the MPEG method.

4. The information outputting apparatus according to claim 1, wherein
the recording information is inputted through broadcasting, and
the control information is information which designates a broadcasting start time of the partial recording information piece and a broadcasting time of the partial recording information piece with respect to each of the partial recording information pieces.

5-11. (canceled)

12. The information outputting apparatus according to claim 2, wherein
the recording information is inputted through broadcasting, and
the control information is information which designates a broadcasting start time of the partial recording information piece and a broadcasting time of the partial recording information piece with respect to each of the partial recording information pieces.

13. The information outputting apparatus according to claim 3, wherein
the recording information is inputted through broadcasting, and
the control information is information which designates a broadcasting start time of the partial recording information piece and a broadcasting time of the partial recording information piece with respect to each of the partial recording information pieces.

14. An information recording apparatus for recording the recording stream which is outputted from the information outputting apparatus according to claim 1, comprising:
an extracting device which extracts the instructing information from the recording stream thus outputted; and
a recording device which records the instructing information thus extracted into the recording medium along with the partial recording information piece corresponding to the instructing information.

15. An information recording apparatus for recording the recording stream which is outputted from the information outputting apparatus according to claim 2, comprising:
an extracting device which extracts the instructing information from the recording stream thus outputted; and
a recording device which records the instructing information thus extracted into the recording medium along with the partial recording information piece corresponding to the instructing information.

16. An information recording apparatus for recording the recording stream which is outputted from the information outputting apparatus according to claim 3, comprising:
an extracting device which extracts the instructing information from the recording stream thus outputted; and
a recording device which records the instructing information thus extracted into the recording medium along with the partial recording information piece corresponding to the instructing information.

17. An information recording apparatus for recording the recording stream which is outputted from the information outputting apparatus according to claim 4, comprising:
an extracting device which extracts the instructing information from the recording stream thus outputted; and
a recording device which records the instructing information thus extracted into the recording medium along with the partial recording information piece corresponding to the instructing information.

18. An information recording apparatus for recording the recording stream which is outputted from the information outputting apparatus according to claim 12, comprising:
an extracting device which extracts the instructing information from the recording stream thus outputted; and
a recording device which records the instructing information thus extracted into the recording medium along with the partial recording information piece corresponding to the instructing information.

19. An information recording apparatus for recording the recording stream which is outputted from the information outputting apparatus according to claim 13, comprising:
an extracting device which extracts the instructing information from the recording stream thus outputted; and
a recording device which records the instructing information thus extracted into the recording medium along with the partial recording information piece corresponding to the instructing information.

20. An information outputting method which converts recording information, which is inputted from an outside as recording information to be recorded into a recording medium, into a recording stream for recording into the recording medium and outputting the recording stream thus converted to the information recording apparatus, comprising steps of:
a detecting step which detects control information respectively of partial recording information pieces, which forms the recording information and includes at least time information designating a change point where a content of the partial recording information piece is changed; and
an outputting step which generates instructing information which designates a boarder of the recording stream on the basis of the control information thus detected, forms the recording stream by inserting the instructing information thus generated into the recording stream, and outputs the recording stream into the information recording apparatus.

21. An information recording method which is conducted by the information recording apparatus which makes the recording medium record the recording stream outputted from the information output method according to claim 20, comprising:
an extracting step which extracts instructing information out of the recording stream; and
a recording step which records the instructing information thus extracted along with a partial recording information piece corresponding to the instructing information.

22. An information output program product which causes an output computer, which is included in an information recording apparatus which converts recording information inputted from an outside as recording information to be recorded into a recording medium, to perform as:
a detecting device which detects control information, which includes at least time information designating a change point where a content of the partial recording information piece forming the recording information is changed, out of the recording information to be inputted; and
an output device which generates instructing information which designates a border of the recording stream on the basis of the control information thus detected, inserts the instructing information thus generated into the recording stream to form the recording stream, and outputs the recording stream to the information recording apparatus.

23. An information recording program product which causes a recording computer, which is included in the information recording apparatus for recording the recording stream outputted from the information outputting apparatus according to claim 22 into the recording medium, to perform as:
an extracting device which extracts the instructing information out of the recording stream thus outputted; and
a recording device which records the instructing information thus extracted along with the partial recording information piece corresponding to the extracted instructing information.

24. An information recording medium which has the information output program product according to claim 22 recorded in it so as to be readable by the output computer.

25. An information recording medium which has the information recording program product according to claim 23 recorded in it so as to be readable by the recording computer.
